(19) United States
(12) Patent Application Publication
(10) Pub. No.: US 2012/0170793 A1
(43) Pub. Date: Jul. 5, 2012

(54) MICRO-SPEAKER

(75) Inventors: Wen-Tao JIANG, Shenzhen (CN); Lei SHI, Shenzhen (CN); Xiong ZHANG, Shenzhen (CN); San-You WU, Shenzhen (CN); Lin-Zhen LI, Shenzhen (CN)

(73) Assignee: AAC ACOUSTIC TECHNOLOGIES (SHENZHEN) CO., LTD., Shenzhen (CN)

(21) Appl. No.: 13/190,563

(22) Filed: Jul. 26, 2011

(30) Foreign Application Priority Data
Jan. 5, 2011 (CN) 201120001513.6

(51) Int. Cl. H04R 1/00

(52) U.S. Cl. 381/412; 381/396

(57) ABSTRACT

A micro-speaker includes a yoke, a magnet assembly attached to the yoke, a voice coil, and a diaphragm connected with the voice coil. The yoke defines a bottom wall, and a number of sidewalls extending upwardly from the bottom wall. The magnet assembly includes a main magnet positioned on the bottom wall, and a number of secondary magnets positioned on tops of the sidewalls.

### FIELD OF THE INVENTION

The present invention relates to the art of speakers, particularly to a micro-speaker used in an electronic device.

### DESCRIPTION OF RELATED ART

Micro-speakers have been widely used in portable electronic devices, such as cellular phones, notebooks, and so on. With the continuing development of the portable electronic devices, people request for more and more functions with audible sensations, which brings a rapid development of the technologies of micro-speakers.

A related micro-speaker includes a bowl-shaped base, an upper cover attached to the base for forming a receiving space therebetween, a permanent magnet and a plate disposed within the base and forming a magnetic gap corporately with the base in the receiving space, a diaphragm adjoining with the upper cover, a voice coil attached to the diaphragm and suspended in the magnetic gap, and a circuit board disposed outside of the base for electrically connecting to an exterior circuit board. Leads of the voice coil pass through corresponding holes provided by the base to connect to the circuit board. When an oscillating electric current is supplied to the voice coil from the circuit board, a corresponding alternate force on the voice coil is generated by a magnetic field produced in the magnetic gap. This compels the voice coil to vibrate, and the oscillating voice coil drives the diaphragm to push ambient air to generate sound. However, the sensitivity of the micro-speaker with the structures mentioned above is too low to satisfy the desired requirements.

Therefore, it is desirable to provide a micro-speaker which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a micro-speaker according to an exemplary embodiment of the present invention.

FIG. 2 is an exploded view of the micro-speaker of FIG. 1.

FIG. 3 is an assembled view of a combination of a yoke, secondary magnets and plates of the micro-speaker.

FIG. 4 is a cross-sectional view of the micro-speaker taken along line IV-IV of FIG. 1.

### DETAILED DESCRIPTION OF THE EMBODIMENT

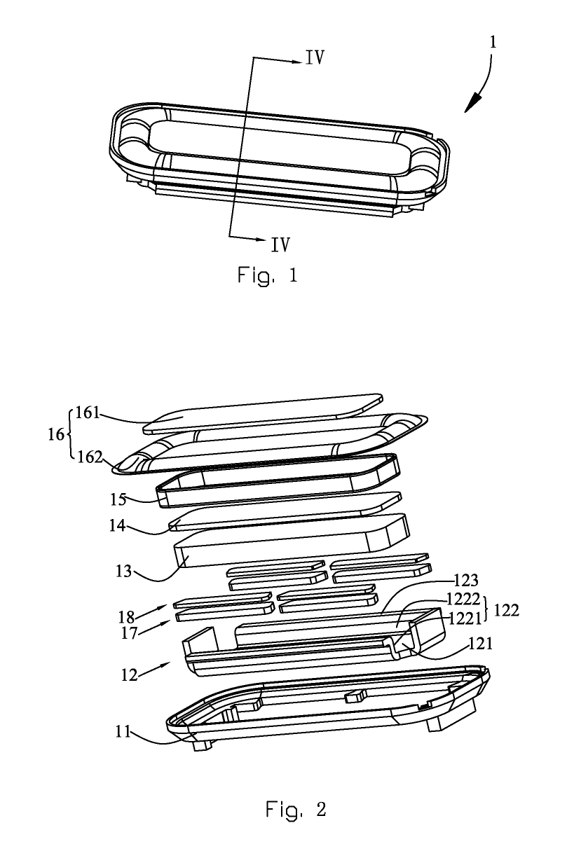

Referring to FIGS. 1-2, a micro-speaker 1 according to an exemplary embodiment, includes a frame 11, a yoke 12 engaged with the frame 11 and defining a receiving space, a main magnet 13 received in the receiving space and forming a first magnetic gap corporately with a plurality of sidewalls 122 of the yoke 12, a pole plate 14 attached on the main magnet 13, a voice coil 15 partially accommodating in the first magnetic gap, and a diaphragm 16 connected with the voice coil 15 and including a top plate 161 and a periphery portion 162 surrounding the top plate 161.

When an oscillating electric current is supplied to the voice coil 15, a corresponding alternate force on the voice coil is generated by a magnetic field produced in the first magnetic gap to compel the voice coil 15 to vibrate, and the voice coil 15 drives the diaphragm 16 to push ambient air to generate sound.

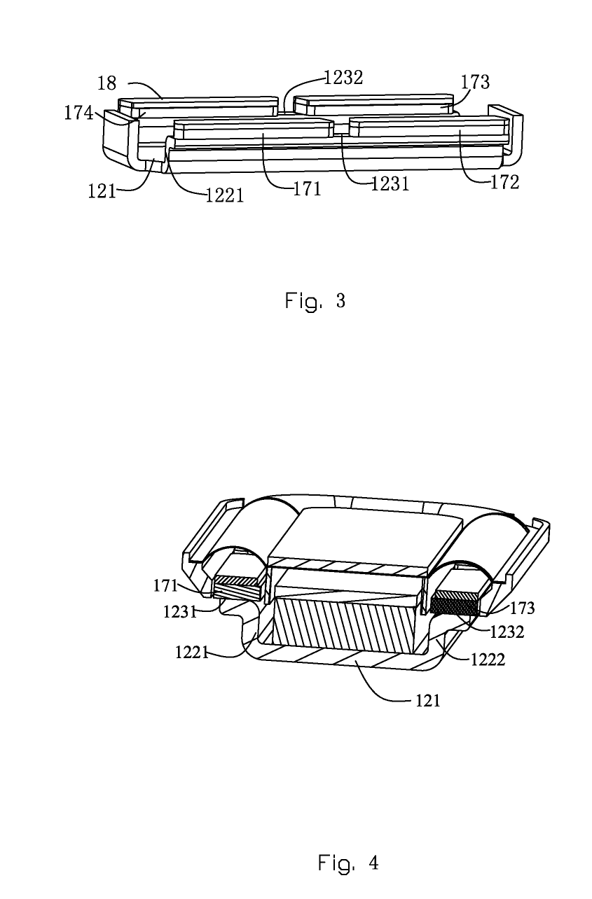

Referring cooperatively to FIG. 3, the yoke 12 further includes a bottom wall 121 extending perpendicularly from the sidewalls 122, and a pair of fringes 123 extending outwards from the sidewalls 122. The sidewalls 122 include a first sidewall 1221 and a second sidewall 1222 opposite to the first sidewall 1221. The fringes 123 include a first fringe 1231 extending outwards from the top side of the first sidewall 1221 along a first direction parallel to the bottom wall 21, and a second fringe 1231 extending outwards from the top side of the second sidewall 1222 along a second direction opposite to the first direction.

Four secondary magnets 17 are disposed on the fringes 123, in which a first secondary magnet 171 and a second secondary magnet 172 are separately disposed on the first fringe 1231, a third secondary magnet 173 and a fourth secondary magnet 174 are separately disposed on the second fringe 1232. The main magnet 13 is disposed on the bottom wall 121. A second magnetic gap is formed between the main magnet 13 and the four secondary magnets 17. The voice coil 15 is partially inserting into the first magnetic gap via the second magnetic gap.

Apparently, when an oscillating electric current is supplied to the voice coil 15, the secondary magnets 17 also provide a corresponding magnetic field in the second magnetic gap to compel the voice coil 15 to vibrate. Therefore, the micro-speaker 1 is more sensitive by adding the secondary magnets 17.

Each of the secondary magnets 17 is provided with a plate 18 thereon. The plates 18 are capable of closing the magnetic fluxes produced by the secondary magnets 17 and generating more effective magnetic flux density for compelling the voice coil 15.

In summary, a micro-speaker in accordance with an exemplary embodiment of the present invention includes a yoke, a magnet assembly attached to the yoke, magnetic gaps formed between the magnet assembly and the yoke, a voice coil partially received in the magnetic gaps, and a diaphragm connected with the voice coil. The yoke defines a bottom wall, and a plurality of sidewalls extending upwardly from the bottom wall. The magnet assembly comprises a main magnet positioned on the bottom wall, and a plurality of secondary magnets positioned on tops of the sidewalls. The magnetic gaps include a first magnetic gap formed between an outer surface of the main magnet and inner surfaces of the sidewalls of the yoke, and a second magnetic gap formed between the main magnet and the secondary magnets. Further, the first magnetic gap is communicated with the second magnetic gap. The voice coil is partially received in the combination of the first and second magnetic gaps. For positioning the secondary magnets firmly, the sidewalls of the yoke define a plurality of fringes extending parallel to the bottom wall for carrying the secondary magnets.

It will be understood that the above-mentioned particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A micro-speaker comprising:
a yoke defining a bottom wall and a plurality of sidewalls extending upwardly from the bottom wall;
a magnet assembly attached to the yoke, including a main magnet positioned on the bottom wall and a plurality of secondary magnets positioned on tops of the sidewalls;
magnetic gaps formed between the magnet assembly and the yoke, including a first magnetic gap formed between an outer surface of the main magnet and a inner surface of the sidewalls of the yoke and a second magnetic gap formed between the main magnet and the secondary magnets, the first magnet gap being communicated with the second magnetic gap;
a voice coil partially received in a combination of the first and second magnetic gaps;
a diaphragm connected with the voice coil.

2. The micro-speaker as claimed in claim 1, wherein the sidewalls of the yoke define a plurality of fringes extending parallel to the bottom wall for carrying the secondary magnets.

3. The micro-speaker as claimed in claim 2, wherein each of the secondary magnets is provided with a plate thereon.

4. The micro-speaker as claimed in claim 4, wherein the plurality of sidewalls includes a first sidewall and a second sidewall opposite to the first sidewall, the plurality of fringes includes a first fringe extending outwards and perpendicularly from a top side of the first sidewall, and a second fringe extending outwards and perpendicularly from a top side of the second sidewall.

5. A micro-speaker comprising:
a frame;
a magnetic circuit unit accommodated in the frame, including a yoke with a receiving space, a main magnet disposed in the receiving space and forming a first magnetic gap corporately with the yoke, at least one secondary magnet attached to the yoke and disposed outside of the receiving space;
a vibrating unit engaged with the frame, including a diaphragm and a voice coil connected with the diaphragm;
a second magnetic gap formed between the main magnet and the at least one secondary magnet; wherein
the voice coil is partially inserting into the first magnetic gap via the second magnetic gap.

6. The micro-speaker as claimed in claim 5, wherein the yoke includes a bottom wall, a first sidewall and a second sidewall separately extending upwards and perpendicularly from two opposite sides of the bottom wall.

7. The micro-speaker as claimed in claim 6, wherein a first fringe extends outwards from a top side of the first sidewall along a first direction parallel to the bottom wall, a second fringe extends outwards from the top side of the second sidewall along a second direction opposite to the first direction.

8. The micro-speaker as claimed in claim 7, wherein each of the first fringe and the second fringe is provided with two divided secondary magnets thereon.

9. The micro-speaker as claimed in claim 8, wherein each of the secondary magnets is provided with a plate thereon.

10. The micro-speaker as claimed in claim 9, wherein the magnet defines a pole plate thereon.

11. A micro-speaker comprising:
a frame;
a magnetic circuit unit accommodated in the frame, including a yoke with a bottom wall carrying a part of the magnetic circuit unit, a plurality of sidewalls extending perpendicularly from the periphery of the bottom wall and including a pair of fringes parallel to the bottom wall, a main magnet disposed on the bottom wall and forming a first magnetic gap corporately with the plurality of sidewalls, and at least two secondary magnets attached to the fringes and locating at the top of the magnetic circuit unit;
a vibrating unit engaged with the frame, including a diaphragm and a voice coil connected with the diaphragm;
a second magnetic gap formed between the main magnet and the at least two secondary magnets; wherein
the voice coil partially inserts into the first magnetic gap via the second magnetic gap.

12. The micro-speaker as claimed in claim 11, wherein each fringe is provided with two secondary magnets, and each secondary magnet is provided with a plate thereon.

13. The micro-speaker as claimed in claim 12, wherein the first magnetic gap communicates with the second magnetic gap.
